(19) United States
(12) Patent Application Publication
(10) Pub. No.: US 2025/0171322 A1
(43) Pub. Date: May 29, 2025

(54) CATALYST SUPPORT MATERIALS FOR USE IN AMMONIA SYNTHESIS

(71) Applicants: Ryan P. O'HAYRE, Golden, CO (US); Christopher A. CADIGAN, Wheat Ridge, CO (US); Jake D. HUANG, Golden, CO (US); Colorado School of Mines, Golden, CO (US)

(72) Inventors: Ryan P. O'HAYRE, Golden, CO (US); Christopher A. CADIGAN, Wheat Ridge, CO (US); Jake D. HUANG, Golden, CO (US)

(21) Appl. No.: 18/843,137

(22) PCT Filed: Mar. 1, 2023
(86) PCT No.: PCT/US2023/063502

§ 371 Date: Aug. 30, 2024

Related U.S. Application Data
(60) Provisional application No. 63/315,408, filed on Mar. 1, 2022.

(51) Int. Cl. C01C 1/04; B01J 23/02; B01J 23/58; B01J 35/30

(52) U.S. Cl. CPC C01C 1/0411; B01J 23/02; B01J 23/58; B01J 35/394

(57) ABSTRACT

Described herein are catalyst support materials for use in synthesizing ammonia (NH₃) from nitrogen gas (N₂) and hydrogen gas (H₂) and methods of making the same. The support material may comprise (MgO)ₓ(BaO)_{y}(Al₂O₃)_{z} and/or (MgO)ₓ(SrO)_{y}(Al₂O₃)_{z}, on which an ammonia synthesis catalyst such as ruthenium is dispersed. When the catalyst support material comprises (MgO)ₓ(BaO)_{y}(Al₂O₃)_{z}, x is from about 0.05 to about 0.7, y is from about 0.05 to about 0.6, and z is from about 0.3 to about 0.5. When the catalyst support material comprises (MgO)ₓ(SrO)_{y}(Al₂O₃)_{z}, x is from about 0.4 to about 0.7, y is from about 0.05 to about 0.5, and z is from about 0.05 to about 0.3.

### CROSS-REFERENCE TO RELATED APPLICATIONS

This application claims priority to U.S. Provisional Patent Application No. 63/315,408, entitled “CATALYST SUPPORT MATERIALS FOR USE IN AMMONIA SYNTHESIS”, filed on Mar. 1, 2022, the entirety of which is hereby incorporated by reference.

### TECHNICAL FIELD

The present disclosure relates to catalyst support materials for use in synthesizing ammonia (NH₃) from nitrogen gas (N₂) and hydrogen gas (H₂). More specifically, the present disclosure relates to a support material comprising (MgO)ₓ(BaO)_{y}(Al₂O₃)_{z} and/or (MgO)ₓ(SrO)_{y}(Al₂O₃)z, on which an ammonia synthesis catalyst such as ruthenium may be dispersed.

### BACKGROUND

The threat to continued economic development and security posed by climate change driven by anthropogenic emissions of carbon dioxide (CO₂) is well-known. To mitigate this threat, energy sources that are substantially free of CO₂ emissions are highly sought after in both developed and developing countries. While several CO₂-free electricity generation options (e.g., wind, solar, hydroelectric, and nuclear power) have been extensively developed, few economical options exist for CO₂-free energy sources.

Ammonia (NH₃) can be burned as a fuel according to the following reaction equation (1):

4NH₃+3O₂→2N₂+6H₂O+heat (1)

Ammonia can also be catalytically reformed to regenerate H2 and N2 reactants according to the following reaction equation (2):

2NH₃→3H₂+N₂ (2)

Thus, NH₃ can be used as a CO₂-free fuel and/or as a hydrogen storage medium. However, nearly all current NH₃ production processes utilize feedstocks and energy sources that generate CO₂.

Prior efforts at sustainable fuel production have focused on biofuels, H₂, and “artificial photosynthesis.” Although ethanol and biodiesel have higher energy density than NH₃, using food resources for fuel production results in higher food prices both by shifting the allocation of cropland from food to fuel and by raising the prices of the crops used for fuel production. This reallocation can cause political instability in developing countries due to higher food prices.

Hydrogen has not yet been able to overcome its storage density challenges, although NH₃ can be regarded as a solution to the H₂ storage density issue. NH₃ has approximately twice the energy density of liquid hydrogen but at easily and economically achieved pressures and temperatures (e.g., about 9 atm at about 25° C.; about 1 atm at about −33° C.).

Although “artificial photosynthesis” could make a closed loop fuel cycle, it must extract CO₂ from the air to do so. Because nitrogen gas is much more abundant (79%) than CO₂ (0.04%) in the atmosphere, the use of NH₃ is a more viable route for a process of this type since less air must be processed to produce the same amount of fuel. For example, synthesizing one mole of methane (CH₄) from atmospheric CO₂ requires processing 3,550 units of air for every one unit of air required to produce one mole of NH₃. Furthermore, commercial air separators for atmospheric N₂ extraction already exist and are well-known, while CO2 extraction from air is still a developing technology.

The main industrial procedure for the production of ammonia is the Haber-Bosch process, illustrated in the following reaction equation (3):

N₂(g)+3H₂(g)→2NH₃(g) (ΔH=−92.2 kJ/mol) (3)

The Haber-Bosch process requires approximately 31.4 gigajoules of energy, annually worldwide, and as of 2017, produces approximately 3 tonnes of CO₂ per tonne of NH₃ produced. About two thirds of the CO₂ emissions from NH₃ synthesis derive from the steam reforming of hydrocarbons to produce hydrogen gas, while the remaining third derives from fuel combustion to provide energy to the synthesis plant. As of 2012, about 50% of Haber-Bosch NH₃ plants used natural gas as feed and fuel, while the remainder used coal or petroleum. As a result, Haber-Bosch NH₃ synthesis consumes between about 3% and about 5% of global natural gas production and between about 1% and about 2% of global energy production. It is thus desirable to provide improvements to methods for synthesizing ammonia that reduce CO₂ emissions.

The Haber-Bosch reaction is generally carried out in a reactor containing an iron oxide or a ruthenium catalyst at a temperature between about 300° C. and about 550° C. and at a pressure between about 90 bar and about 180 bar. The elevated temperature is required to achieve a reasonable reaction rate. However, reaction equilibrium becomes less favorable for reaction product (NH₃) as reaction temperature increases, so elevated pressure is used to “push” the reaction according to the Le Chatelier principal. In addition, an increase in reaction pressure increases reaction rate (i.e., rate is a function of reactant pressure). The pressurization of H₂ and N₂ gases is both energetically and economically expensive due to the power requirements of compressors and the increased cost of equipment that can withstand high pressures, so improvements to catalyst activity that provide similar or better reaction rates at lower temperatures and pressures are desirable.

NH₃ catalyst activity may be improved by applying the catalyst to the surface of certain support materials. Dispersing catalyst on the surface of a support material has at least three advantages. First, high-dispersion deposition of catalyst particles on the support (i.e., deposition of particles to maximize the ratio of exposed surface area to particle volume) allows more efficient use of the catalyst. Second, the support can supply and/or consume valence electrons from the catalyst, lowering the energetic barriers to adsorption, desorption, or reaction of reactants or surface intermediates. Third, the support can provide a co-catalytic function where intermediate reactions occur on both catalyst and support simultaneously with a lowered activation barrier (e.g., when a support binds to an intermediate species allowing the catalyst to remove an atom from the reactant (e.g., H)).

Support materials that have been mentioned for use with NH₃ catalysts in the literature include activated carbon, aluminum oxide, Al₂O₃, CaO, calcium amide (Ca(NH₂)₂), and mayenite electride (C12A7:e—in cement chemistry notation). U.S. Patent Application Publication Nos. 2017/0253492 and 2020/0197911 also describe the use of various catalyst supports, including calcium aluminate materials such as CA, C5A3, C3A and C (cement chemistry notation, C═CaO, A=Al₂O₃), in both their electrically insulating and their electrically conductive forms. These applications are incorporated herein by reference in their entirety.

In order to further facilitate the efficient production of NH₃ using the methods described above, the development of improved catalysts, including improved catalyst supports, is highly desired.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a catalyst support material suitable for use in, e.g., synthesizing ammonia from H₂ and N₂, includes (MgO)ₓ(BaO)_{y}(Al₂O₃)_{z}, wherein x is from about 0.05 to about 0.7, y is from about 0.05 to about 0.6, and z is from about 0.3 to about 0.5. The support material may comprise material having the chemical formula (MgO)ₓ(BaO)_{y}(Al₂O₃)_{z}, wherein x is from about 0.05 to about 0.7, y is from about 0.05 to about 0.6, and z is from about 0.3 to about 0.5, or may comprise two or more materials that, when their compositional content is averaged, the composition of the two or more materials has the chemical formula (MgO)ₓ(BaO)_{y}(Al₂O₃)_{z}, wherein x is from about 0.05 to about 0.7, y is from about 0.05 to about 0.6, and z is from about 0.3 to about 0.5. An ammonia-synthesizing catalyst may be dispersed on the catalyst support material. The ammonia-synthesizing catalyst may be, but is not limited to, ruthenium.

In some embodiments, a catalyst support material suitable for use in, e.g., synthesizing ammonia from H₂ and N₂, includes, in bulk, (MgO)ₓ(SrO)_{y}(Al₂O₃)_{z}, wherein x is from about 0.4 to about 0.7, y is from about 0.05 to about 0.5, and z is from about 0.05 to about 0.3. The support material may comprise material having the chemical formula (MgO)ₓ(SrO)_{y}(Al₂O₃)_{z}, wherein x is from about 0.4 to about 0.7, y is from about 0.05 to about 0.5, and z is from about 0.1 to about 0.3, or may comprise two or more materials that, when their compositional content is averaged, the composition of the two or more materials has the chemical formula (MgO)ₓ(SrO)_{y}(Al₂O₃)_{z}, wherein x is from about 0.4 to about 0.7, y is from about 0.05 to about 0.5, and z is from about 0.05 to about 0.3. An ammonia-synthesizing catalyst may be dispersed on the catalyst support material. The ammonia-synthesizing catalyst may be, but is not limited to, ruthenium.

In some embodiments, a method of synthesizing NH₃ from a mixture of N₂ and H₂ mixture includes at least the step of exposing a mixture of N₂ and H₂ to a catalyst dispersed on a support material, the support material including either (MgO)ₓ(BaO)_{y}(Al₂O₃)_{z}, wherein x is from about 0.05 to about 0.7, y is from about 0.05 to about 0.6, and z is from about 0.3 to about 0.5, or (MgO)ₓ(SrO)_{y}(Al₂O₃)_{z}, wherein x is from about 0.4 to about 0.7, y is from about 0.05 to about 0.5, and z is from about 0.05 to about 0.3. The support material may have one of the chemical formulas described previously either by use of material having the previously described chemical formula, or by use of two or more materials that, on average, provides a composition having the previously described chemical formula. The catalyst dispersed on the support material may be an ammonia-synthesizing catalyst, such as (but not limited to) ruthenium.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a ternary plot for (MgO)ₓ(BaO)_{y}(Al₂O₃)_{z} illustrating a preferred range of compositions for (MgO)ₓ(BaO)_{y}(Al₂O₃)_{z} to achieve improved ammonia synthesis when using (MgO)ₓ(BaO)_{y}(Al₂O₃)_{z} as a support material for an ammonia-synthesizing catalyst according to various embodiments described herein.

FIG. 2 is a ternary plot for (MgO)ₓ(SrO)_{y}(Al₂O₃)_{z} illustrating a preferred range of bulk compositions for (MgO)ₓ(SrO)_{y}(Al₂O₃)_{z} to achieve improved ammonia synthesis when using (MgO)ₓ(SrO)_{y}(Al₂O₃)_{z} as a support material for an ammonia-synthesizing catalyst according to various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The present disclosure describes various embodiments of catalyst support materials, and in some particular embodiments, support materials for use with ammonia-synthesizing catalysts. For example, ammonia-synthesizing catalysts may be dispersed on the support materials described herein. Any suitable methods for forming the support materials described herein may be used. Similarly, any suitable methods for dispersing ammonia-synthesizing catalyst on the support material with can be used. Exemplary, though non-limiting, methods for forming the support materials described herein and for dispersing catalyst on the support materials described herein are described in greater detail in US Patent Application Publication No. 2020/0197911, the entirety of which is hereby incorporated by reference.

In brief, and not to be taken in a limiting sense, the methods for forming support materials as described in US Patent Application Publication No. 2020/0197911 that may be employed with the technology disclosed herein generally comprise mixing together a contributor material of each of the components in the support material and calcining the mixture such that an oxide form of the component included in the support material is made from the contributor material. The term “contributor” as used herein means a compound that includes a component of the final support material and which is used to create an oxide form of the component as part of the process of forming the support material. In some embodiments, the components of the support material are Mg, Ba and Al, while in other embodiments, the components of the support material are Mg, Sr and Al. As such, the contributors used in the methods described herein will include Mg contributors, Sr contributors and Al contributors, or Mg contributors, Ba contributors and Al contributors, such that oxide forms of these components (e.g., MgO, BaO, SrO, Al₂O₃) can be made from the contributor materials via calcining. Any contributor material suitable for use in creating these oxide forms via annealing may be used. Exemplary, though non-limiting, contributors suitable for use in the formation of the support materials described herein include:
For MgO: magnesium (metal), magnesium oxide, magnesium hydroxide, magnesium hydroxide carbonate, magnesium acetate, magnesium carbonate, magnesium nitrate, magnesium methyl carbonate, and magnesium acetylacetonate.
For BaO: barium (metal), barium carbonate, barium acetate, barium nitrate, barium oxide, barium isopropoxide, barium hydroxide, barium peroxide, barium 2-ethylhexanoate, and barium acetylacetonate.
For SrO: strontium (metal), strontium nitrate, strontium hydroxide, strontium isopropoxide, strontium acetate, strontium oxide, strontium aluminate, strontium carbonate, strontium tetramethylheptanedionate, strontium nitride, and strontium acetylacetonate.
For Al₂O₃: aluminum (metal), aluminum oxide, aluminum nitrate, aluminum hydroxide, aluminum acetylacetonate, and aluminum acetate.

Regardless of the specific manner in which the contributor materials are mixed and calcined, including whatever additional steps are carried out as part of preparing the mixture to be calcined, the support material formed from the calcining step may be in any form, such as in powder or agglomerate form. Additional steps can be carried out to alter the form of the support material, such as mixing the powder or agglomerate form with any combination of binders, lubricants, and/or porogens, and shaping the material into e.g., pellets, extrudates, monoliths, screen, honeycombs, or sheets.

As also discussed in more detail in U.S. Patent Application Publication No. 2020/0197911, the form of the contributor materials when mixed is generally not limited. In some embodiments, the contributor materials are provided in the form of a powder, which can then be mixed together to form a powder mixture. The powder mixture may be directly calcined, or additional steps may be carried out to alter the form of the mixture prior to calcining. For example, a solvent may be added to the mixture of contributor materials to form a paste or slurry, which may then be calcined. Alternatively, the paste or slurry may then be dried to form a dry mixture, which can then be calcined. The powder form of the contributor materials or mixtures thereof may also be comminuted and/or ball milled to reduce the particle size of the powder materials as part of the process of forming the support materials (e.g., prior to calcining).

The amount of each contributor used in preparing the mixture to be annealed as part of the formation of the support material is generally governed by the desired composition of the support material to be created. The various contributors can be combined at different molar ratios to produce different stoichiometry support materials. Further discussion of the desired stoichiometric ratios for the support materials of the present technology is provided below.

Additional aspects of the methods for producing the support material, including but not limited to, the temperature ranges used for calcining, hold/soak time at calcining, the rate of temperature increase to the calcining temperature, the rate of temperature decrease upon completion of calcining, the creation of an electrically conductive material, etc., are described in further detail in U.S. Patent Application Publication No. 2020/0197911 and may be employed in the methods for making the support materials described herein.

Once produced, a catalyst material, such as an ammonia-synthesizing catalyst material, may be dispersed on the support materials. In brief, and not to be taken in a limiting sense, the methods for dispersing catalyst on the support materials as described in US Patent Application Publication No. 202/0197911 that may be employed with the technology disclosed herein include incipient wetness techniques, balling milling methods, ion-exchange, and wet impregnation methods. Other methods that may be used include nanoparticle dispersion, nanoparticle ligand exchange, chemical vapor deposition, and physical vapor deposition.

Having briefly described the methods suitable for use in the forming the support materials described herein, the desired composition of the support materials can now be described. In some embodiments, the support material comprises (MgO)ₓ(BaO)_{y}(Al₂O₃)_{z} or (MgO)ₓ(SrO)_{y}(Al₂O₃)_{z}. For each material, it has been found that the ammonia synthesis rate is beneficially improved when using the support material having an ammonia-synthesizing catalyst such as ruthenium dispersed thereon, provided the values for x, y and z are within a specified range. Ammonia synthesis rates are improved at least in comparison to support materials having (MgO)ₓ(BaO)_{y}(Al₂O₃)_{z} or (MgO)ₓ(SrO)_{y}(Al₂O₃)_{z} where the values for x, y and/or z fall outside of the specified ranges and on which an ammonia-synthesizing catalyst is dispersed. In some embodiments, ammonia synthesis rates are improved when the support material is (MgO)ₓ(BaO)_{y}(Al₂O₃)_{z}, the value for x is in the range of from about 0.05 to about 0.7, the value for y is in the range of from about 0.05 to about 0.6, and the value for z is in the range of from about 0.3 to about 0.5. In some embodiments, ammonia synthesis rates are improved when the support material is (MgO)ₓ(SrO)_{y}(Al₂O₃)_{z}, the value for x is in the range of from about 0.4 to about 0.7, the value for y is in the range of from about 0.05 to about 0.5, and the value for z is in the range of from about 0.05 to about 0.3.

The values for x, y and z provided above are stoichiometric values. It should be appreciated that the values for x, y and z may be multiplied or divided by any common value and still fall within the scope of the presently described technology. The values for x, y and z provided herein represent reduced values for x, y and z. Thus, a support material comprising (MgO)_{2.1}(BaO)_{0.15}(Al₂O₃)_{0.9} can be reduced by a common factor of 3 to arrive at (MgO)_{0.7}(BaO)_{0.05}(Al₂O₃)_{0.3}, and both compositions are considered to fall within the scope of the presently described technology.

In some embodiments, the support materials described herein comprise material that itself has the chemical formula (MgO)ₓ(BaO)_{y}(Al₂O₃)_{z}, where the value for x is in the range of from about 0.05 to about 0.7, the value for y is in the range of from about 0.05 to about 0.6, and the value for z is in the range of from about 0.3 to about 0.5, or the chemical formula (MgO)ₓ(SrO)_{y}(Al₂O₃)_{z}, where the value for x is in the range of from about 0.4 to about 0.7, the value for y is in the range of from about 0.05 to about 0.5, and the value for z is in the range of from about 0.05 to about 0.3. In other embodiments, the support materials comprise a composition of two or more materials that, in bulk, averages out to the overall support material having the chemical formula (MgO)ₓ(BaO)_{y}(Al₂O₃)_{z}, where the value for x is in the range of from about 0.05 to about 0.7, the value for y is in the range of from about 0.05 to about 0.6, and the value for z is in the range of from about 0.3 to about 0.5, or the chemical formula (MgO)ₓ(SrO)_{y}(Al₂O₃)_{z}, where the value for x is in the range of from about 0.4 to about 0.7, the value for y is in the range of from about 0.05 to about 0.5, and the value for z is in the range of from about 0.05 to about 0.3. In such embodiments, the composition may be comprised of two or more materials that do not themselves have the chemical formula (MgO)ₓ(BaO)_{y}(Al₂O₃)_{z} or (MgO)ₓ(SrO)_{y}(Al₂O₃)_{z}, and/or that have the chemical formula (MgO)ₓ(BaO)_{y}(Al₂O₃)_{z} or (MgO)ₓ(SrO)_{y}(Al₂O₃)_{z}, but with values for x, y and/or z that fall outside the previously stated ranges. However, when the sum of atomic contents from two or more materials is averaged, the composition comprising the two more materials has a chemical formula of (MgO)ₓ(BaO)_{y}(Al₂O₃)_{z} or (MgO)ₓ(SrO)_{y}(Al₂O₃)_{z} where the values for x, y and z fall within the previously stated ranges. The materials used in such bulk compositions may have a crystalline or amorphous form, and therefore the bulk composition may include mixtures of amorphous and crystalline materials.

In one non-limiting example for a bulk composition having two or more materials that average out to providing a composition having the chemical formula (MgO)ₓ(BaO)_{y}(Al₂O₃)_{z}, where the value for x is in the range of from about 0.05 to about 0.7, the value for y is in the range of from about 0.05 to about 0.6, and the value for z is in the range of from about 0.3 to about 0.5, the composition for the structural material may have equal amounts of a first material having the chemical formula (MgO)_{0.3}(BaO)_{0.2}(Al₂O₃)_{0.6} and a second material having the chemical formula (MgO)_{0.2}(BaO)_{0.6}(Al₂O₃)_{0.2}. Despite each material not individually having the chemical formula as previously described (since the value for z in the first material and second material is outside the range of 0.3 to 0.5), the average of each of the MgO, BaO and Al₂O₃ components provides a final composition having, in bulk, the chemical formula (MgO)_{0.25}(BaO)_{0.4}(Al₂O₃)_{0.4}, which represents a material that having the chemical formula as previously described.

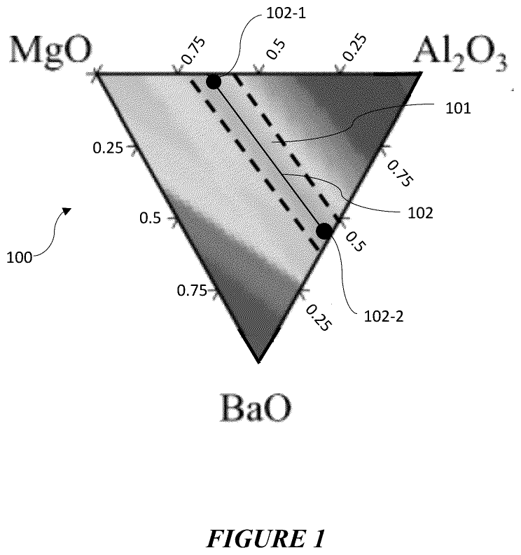

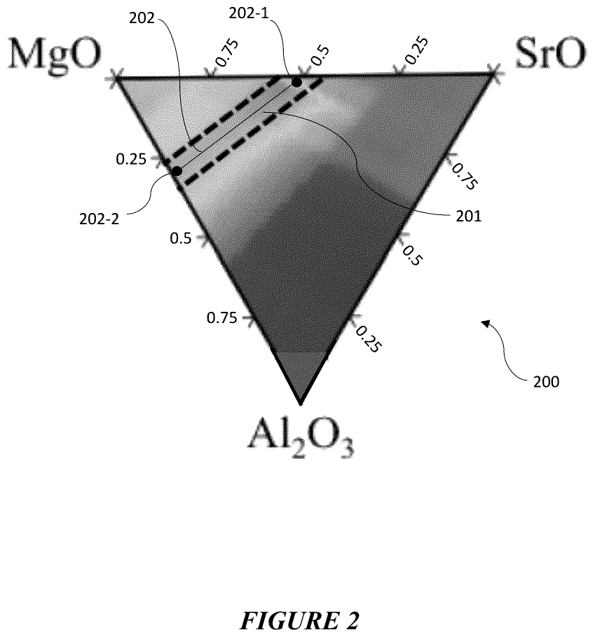

With reference now to FIGS. 1 and 2, a ternary plot is shown for the preferred composition range of each of (MgO)ₓ(BaO)_{y}(Al₂O₃)_{z} and (MgO)ₓ(SrO)_{y}(Al₂O₃)_{z}. The ternary plots shown in FIGS. 1 and 2 can be read using any of a grid method, an altitude method, or an intersection method, as well known by those of ordinary skill in the art. Generally speaking, for each ternary plot, the side of the triangle opposite a vertex indicates where none of the compound labeled at the vertex is provided, and the amount of the compound labeled at the vertex increases as the vertex is approached from the side opposite the vertex. Thus, for example, a data point on the ternary plot that is close to a vertex indicates a material having a relatively high amount of the compound labeled at the vertex.

The regions on each ternary plot shown generally in a medium grey color and bounded by dashed lines in FIGS. 1 and 2 indicate the compositions of support material having increased ammonia synthesis rates when an ammonia-synthesizing catalyst such as ruthenium is dispersed on the support materials (at least as compared to the compositions shown in the ternary plots that fall outside of the medium grey regions.

Referring first to FIG. 1, the ternary plot 100 for a support material having the chemical formula (MgO)ₓ(BaO)_{y}(Al₂O₃)_{z} is shown, wherein region 101 represents the composition of the (MgO)ₓ(BaO)_{y}(Al₂O₃)_{z} support material having improved ammonia synthesis as compared to other (MgO)ₓ(BaO)_{y}(Al₂O₃)_{z} support material compositions shown on ternary plot 100 but which fall outside of region 101. The preferred compositions of (MgO)ₓ(BaO)_{y}(Al₂O₃)_{z} support material generally fall within region 101, with a linear plot line 102 extending through the middle of region 101 representing, in some embodiments, the most preferred compositions. In some embodiments, linear plot line 102 extends between the plot points for (MgO)_{0.65}(BaO)_{0.05}(Al₂O₃)_{0.35} (labeled 102-1 in FIG. 1) and (MgO)_{0.05}(BaO)_{0.55}(Al₂O₃)_{0.40} (labeled 102-2 in FIG. 1) on the ternary plot 100. Other points falling approximately on plot line 102 include, but are not limited to, (MgO)_{0.5}(BaO)_{0.2}(Al₂O₃)_{0.35}, (MgO)_{0.25}(BaO)_{0.4}(Al₂O₃)_{0.37}, and (MgO)_{0.15}(BaO)_{0.5}(Al₂O₃)_{0.4}. However, as noted previously, plot points near this linear plot line 102 (e.g., at least within region 101) also provide compositions for preferred (MgO)ₓ(BaO)_{y}(Al₂O₃)_{z} support material. Support material compositions that fall adjacent to but not directly on linear plot line 102 between the points 102-1 and 102-2 should still be considered as falling within the scope of the presently described technology.

Referring next to FIG. 2, the ternary plot 200 for a support material having the chemical formula (MgO)ₓ(SrO)_{y}(Al₂O₃)_{z} is shown, wherein region 201 represents the composition of the (MgO)ₓ(SrO)_{y}(Al₂O₃)_{z} support material having improved ammonia synthesis as compared to other (MgO)ₓ(SrO)_{y}(Al₂O₃)_{z} support material compositions shown on ternary plot 200 but which fall outside of region 201. The preferred compositions of (MgO)ₓ(SrO)_{y}(Al₂O₃)_{z} support material generally fall within region 201, with a linear plot line 202 extending through the middle of region 201 representing, in some embodiments, the most preferred compositions. In some embodiments, linear plot line 202 extends between the plot points for (MgO)_{0.5}(SrO)_{0.5}(Al₂O₃)_{0.05} (labeled 202-1 in FIG. 2) and (MgO)_{0.7}(SrO)_{0.05}(Al₂O₃)_{0.3} (labeled 202-2 in FIG. 2) on the ternary plot 200. Other points falling approximately on plot line 102 include, but are not limited to, (MgO)_{0.62}(SrO)_{0.12}(Al₂O₃)_{0.24}, (MgO)_{0.6}(SrO)_{0.3}(Al₂O₃)_{0.13}, and (MgO)_{0.58}(SrO)_{0.37}(Al₂O₃)_{0.08}. However, as noted previously, plot points near this linear plot line 202 (e.g., at least within region 201) also provide compositions for preferred (MgO)ₓ(SrO)_{y}(Al₂O₃)_{z} support material. Support material compositions that fall adjacent to but not directly on linear plot line 202 between the points 202-1 and 202-2 should still be considered as falling within the scope of the presently described technology. In some embodiments, a preferred support material has the chemical formula at or near the plot point for (MgO)_{0.6}(SrO)_{0.4}(Al₂O₃)_{0.15}.

Once a support material having a composition as described above is formed, an ammonia-synthesizing catalyst can be dispersed on the support material. Any suitable catalyst known to promote the formation of ammonia from N₂ and H₂ or other reactants can be used. In some embodiments, the ammonia-synthesizing catalyst is at least one transition metal selected from the group consisting of Ti, V, Cr, Mn, Fe, Co, Ni, Cu, Mo, Ru, Rh, Pd, or Os. Any combination of ammonia-synthesizing catalysts can be used when dispersing catalyst on the support material.

In some embodiments, the amount of catalyst dispersed on the support material is in the range of from about 0.01 to about 50 wt %, such as from about 0.1 to about 20 wt %, from about 0.1 to about 10 wt %, or about 1 wt %. Dispersion of a catalyst on the support material can be carried out using any suitable methodology, including but not limited to in a manner similar or identical to the methods described in U.S. Patent Application Publication No. 2020/0197911. When following the methods described in U.S. Patent Application Publication No. 2020/0197911, dispersion is generally carried out by (a) stirring the support material powder in a metal salt+acetone solution to disperse on its surface a salt of the desired metal, and (b) reducing the resulting material in hydrogen-containing atmosphere to convert the catalyst metal salt to catalyst metal. Non-limiting examples of suitable metal salts are RuCl₃ hydrate for Ru dispersion and CoCl₂ hexahydrate for Co dispersion. Multiple catalysts can be added to the support by using a solution that contains the multiple catalyst salts, by depositing and reducing the catalyst metals in succession, or by a combination of the two methods.

In some embodiments, an oxide form of the catalyst can be formed by performing the calcining step in a non-reducing environment. For example, a Co/support material catalyst can be converted to a Co-oxide/support material catalyst by calcining the Co/support material in an oxygen-containing atmosphere.

Thus formed, the support material composition having catalyst dispersed thereon can be formed into a catalyst bed by any of the methods described in U.S. Patent Application Publication No. 2020/0197911, or via any other suitable method. The methods described in U.S. Patent Application Publication No. 2020/0197911 include, as examples, using the material as a powder, extruding it into shapes (e.g., pellets), pressing it into pellets, or bonding it to structural supports. It has been found that metal monoliths with a thin layer catalyst bonded to their surface are particularly beneficial for NH₃ synthesis due to their high thermal conductivity and high catalyst utilization.

In exemplary catalyst synthesis methods, the catalyst bed or monolith is heated to 200 to 650° C. and a N₂+H₂ gas mixture is directed through it. The gas pressure can range from 0.1 bar to 500 bar absolute. The reactant input stream can be preheated before it is directed into the catalyst bed. When the N₂+H₂ gas mixture flows through the hot catalyst bed, a portion of it is converted to NH₃. The concentration of NH₃ in the product gas can vary depending on temperature, pressure, gas velocity, and gas/catalyst contact time.

The thermodynamic equilibrium concentration of NH₃ in the product stream can be increased by reducing the catalyst bed temperature, increasing reactant pressure, or both. NH₃ synthesis is an exothermic process, so the catalyst and reactant gas increase in temperatures as NH₃ is synthesized. This can be particularly important at high operating pressures, for which heat removal mechanisms may be required to keep the reactor from overheating.

For a given catalyst bed volume, temperature, and pressure, the fraction of the incoming N₂+H₂ that is converted to NH₃ can be brought closer to the thermodynamic equilibrium value by increasing the residence time in the catalyst bed by reducing the NH₃ flow rate.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

We claim:

1. A catalyst support material having the chemical formula (MgO)ₓ(BaO)_{y}(Al₂O₃)_{z}, wherein x is from about 0.05 to about 0.7, y is from about 0.05 to about 0.6, and z is from about 0.3 to about 0.5.

2. The catalyst support material of claim 1, wherein the values for x, y and z in (MgO)ₓ(BaO)_{y}(Al₂O₃)_{z} are taken from data points on or about a linear plot line extending between the points (MgO)_{0.65}(BaO)_{0.05}(Al₂O₃)_{0.35} and (MgO)_{0.05}(BaO)_{0.55}(Al₂O₃)_{0.4} on a ternary plot for MgO, BaO and Al₂O₃.

3. The catalyst support material of claim 1, wherein an ammonia-synthesizing catalyst is dispersed on the catalyst support material.

4. The catalyst support material of claim 3, wherein the ammonia-synthesizing catalyst comprises ruthenium.

5. The catalyst support material of claim 3, wherein the ammonia-synthesizing catalyst comprises at least one of Ti, V, Cr, Mn, Fe, Co, Ni, Cu, Mo, Ru, Rh, Pd, or Os.

6. The catalyst support material of claim 3, wherein the amount of ammonia-synthesizing catalyst dispersed on the catalyst support material is from about 0.5 wt. % to about 20 wt. % of the combined catalyst support material and ammonia-synthesizing catalyst dispersed thereon.

7. The catalyst support material of claim 1, wherein the catalyst support material comprises two or more materials, and the average of the compositional content of the two or more materials provides a material having the chemical formula (MgO)ₓ(BaO)_{y}(Al₂O₃)_{z} wherein x is from about 0.05 to about 0.7, y is from about 0.05 to about 0.6, and z is from about 0.3 to about 0.5

8. A catalyst support material comprising (MgO)ₓ(SrO)_{y}(Al₂O₃)_{z}, wherein x is from about 0.4 to about 0.7, y is from about 0.05 to about 0.5, and z is from about 0.05 to about 0.3.

9. The catalyst support material of claim 8, wherein (MgO)ₓ(SrO)_{y}(Al₂O₃)_{z} is (MgO)_{0.6}(SrO)_{0.4}(Al₂O₃)_{0.15}.

10. The catalyst support material of claim 8, wherein the values for x, y and z in (MgO)ₓ(SrO)_{y}(Al₂O₃)_{z} are taken from data points on or about a linear plot line extending between the points (MgO)_{0.5}(SrO)_{0.5}(Al₂O₃)_{0.05} and (MgO)_{0.7}(SrO)_{0.05}(Al₂O₃)_{0.3} on a ternary plot for MgO, SrO and Al₂O₃.

11. The catalyst support material of claim 8, wherein an ammonia-synthesizing catalyst is dispersed on the catalyst support material.

12. The catalyst support material of claim 11, wherein the ammonia-synthesizing catalyst comprises ruthenium.

13. The catalyst support material of claim 11, wherein the ammonia-synthesizing catalyst comprises at least one of Ti, V, Cr, Mn, Fe, Co, Ni, Cu, Mo, Ru, Rh, Pd, or Os.

14. The catalyst support material of claim 11, wherein the amount of ammonia-synthesizing catalyst dispersed on the catalyst support material is from about 0.5 wt. % to about 20 wt. % of the combined catalyst support material and ammonia-synthesizing catalyst dispersed thereon.

15. A method of synthesizing NH₃ from a mixture of N₂ and H₂ mixture comprising:
exposing a mixture of N₂ and H₂ to a catalyst support material having ammonia-synthesizing catalyst dispersed thereon, the support material comprising either:
(MgO)ₓ(BaO)_{y}(Al₂O₃)_{z}, wherein x is from about 0.05 to about 0.7, y is from about 0.05 to about 0.6, and z is from about 0.3 to about 0.5; or
(MgO)ₓ(SrO)_{y}(Al₂O₃)_{z}, wherein x is from about 0.4 to about 0.7, y is from about 0.05 to about 0.5, and z is from about 0.05 to about 0.3.

16. The method of claim 15, wherein when the support material is (MgO)ₓ(BaO)_{y}(Al₂O₃)_{z}, the values for x, y and z in (MgO)ₓ(BaO)_{y}(Al₂O₃)_{z} are taken from data points on or about a linear plot line extending between the points (MgO)_{0.65}(BaO)_{0.05}(Al₂O₃)_{0.35} and (MgO)_{0.05}(BaO)_{0.55}(Al₂O₃)_{0.4} on a ternary plot for MgO, BaO and Al₂O₃, and when the support material is (MgO)ₓ(SrO)_{y}(Al₂O₃)_{z}, the values for x, y and z in (MgO)ₓ(SrO)_{y}(Al₂O₃)_{z} are taken from data points on or about a linear plot line extending between the points (MgO)_{0.5}(SrO)_{0.5}(Al₂O₃)_{0.05} and (MgO)_{0.7}(SrO)_{0.05}(Al₂O₃)_{0.3} on a ternary plot for MgO, SrO and Al₂O₃.

17. The method of claim 15, wherein the ammonia-synthesizing catalyst comprises ruthenium.

18. The method of claim 15, wherein the ammonia-synthesizing catalyst comprises at least one of Ti, V, Cr, Mn, Fe, Co, Ni, Cu, Mo, Ru, Rh, Pd, or Os.

19. The method of claim 15, wherein the amount of ammonia-synthesizing catalyst dispersed on the catalyst support material is from about 0.5 wt. % to about 20 wt. % of the combined catalyst support material and ammonia-synthesizing catalyst dispersed thereon.

20. The method of claim 19, wherein the amount of ammonia-synthesizing catalyst dispersed on the catalyst support material is about 1.0 wt. of the combined catalyst support material and ammonia-synthesizing catalyst decorated thereon.
